(19) United States
(12) Patent Application Publication
(10) Pub. No.: US 2011/0125820 A1
(43) Pub. Date: May 26, 2011

(54) Telecommunication network aggregation cache system and method

(76) Inventor: Yi-Neng Lin, Science-Park Hsinchu City (TW)

(21) Appl. No.: 12/591,613

(22) Filed: Nov. 25, 2009

(51) Int. Cl. G06F 12/08; G06F 15/16

(52) U.S. Cl. 709/201; 711/118; 711/E12.017

(57) ABSTRACT

A telecommunication network aggregation cache system and method is disclosed. An aggregation point or a mesh network formed by a plurality of aggregation points is arranged between sites and a core network to serve as a relay. A cache server in the aggregation point is used to store cache objects. Cache objects corresponding to request in packets sent from a user entity are retrieved from the cache server and sent back to the user entity. If the requested cache object is not found on a local cache server the aggregation point searches neighboring cache servers in the mesh network. If the cache object is found it is retrieved and sent back to the user entity. If the object is not found on either the local cache server or the neighboring cache servers, the requested object is retrieve from the Internet via a core network and sent to the user entity.

### BACKGROUND OF THE INVENTION

1. Field of the Invention

The present invention relates to a telecommunication network aggregation cache system and method, and in particular to a telecommunication network aggregation cache system and method that can be implemented by making use of 3.9G, 4G, and 802.16 communication specification standards.

2. The Prior Art

The increase in popularity of accessing the Internet using mobile communication devices has led to a serious overloading of the signal transmission facilities. For example, the IP-based 3.9G (LTE, LTE-advanced) specified by 3GPP, IMT-Advanced (4G) of ITU (International Telecommunication Union), and the 802.16 of WiMAX (World Worldwide Interoperability for Microwave Access) forum, have made the backhaul to become a bottleneck in communications. As such, the bandwidth used in data transmission from a base station (BS) to a next stop (such as a serving gateway (S-GW) in LTE, or an access service network gateway (ASN-GW) in 802.16 in the direction to a core network will be severely insufficient. In this respect, the LTE technology of 3GPP is taken as an example. Wherein, a base station includes 3 sectors, and a site is formed by at least three base stations. According to the LTE specification, in a 20 MHz environment, the upload/download capacities of a sector for mobile communication devices are 50Mbps/100 Mbps respectively. Therefore, the overall throughput of a site can reach as high as 3*3*(100+50)=1350 Mbps, which is quite beyond the load of T1/E1-based backhaul presently. An additional problem is how to fulfill the more stringent IMT-Advanced specification.

U.S. Pat. No. 6,941,338/B1 discloses a cache provided in each of the base stations. When a base station receives a message containing a request, the base station will send out the cached data corresponding to the request in the message.

However, providing cache in a base station using this method has several drawbacks. Firstly, since the category and scope of data in a cache is relatively broad, a large amount of hardware is required for storage. Secondly, if cached objects are not frequently shared the system is not effectively or efficiently utilized. Thirdly, if the range covered by a base station is not wide the number of users benefiting from this arrangement is quite limited. Because of these factors the system of the prior art is expensive and not cost effective. Furthermore, in situations or conditions where there are not a sufficient number of users, the cached data may not be comprehensive enough to sustain a satisfactory cache hit ratio.

### SUMMARY OF THE INVENTION

In view of the problems and shortcomings of the prior art, the present invention provides a telecommunication network aggregation cache system and method, that combines an effective aggregation concept and cache mechanism while in compliance with communication specifications.

An objective of the present invention is to provide a telecommunication network aggregation cache system and method, wherein, a cache server is provided at an aggregation point in order for the cache mechanism to be used effectively. The present invention saves the high level backhaul bandwidth and significantly increases the efficacy of communication transmission.

Another objective of the present invention is to provide a telecommunication network aggregation cache system and method, wherein, the cached objects may be comprehensive enough to sustain a satisfactory hit ratio.

A further objective of the present invention is to provide a telecommunication network aggregation cache system and method, wherein, a piece-wise object storage caching mechanism between cache servers in a mesh network is utilized to refrain from data duplication and reduce the storage space required by cache servers. As a result the overall cost of hardware storage space is reduced.

In the present invention at least one site is used to receive and transmit at least one packet, and at least one aggregation point is connected to the site. The aggregation point is provided with a cache server that is used to store cached objects. A mesh network is formed by aggregation points through virtual connections between the aggregation points. The cache server of each aggregation point is a neighboring cache to each other. A core network is connected to an aggregation point or to a mesh network formed by multiple aggregation points. A data network gateway is provided for the core network to connect to the Internet. A cache server can also be provided in the data network gateway. The cache server provided in the data network gateway is a parent cache and the cache server provided in a mesh network is a child cache. The packets sent by a site are transmitted to a cache server of an aggregation point through a low level backhaul aggregation route. The aggregation point receives and checks the request contained in a user-plane packet and sequentially checks a local cache, a neighboring cache, and a parent cache to determine if the objects stored therein correspond to the cache object required by the request contained in the packet. If the answer is negative, then, through a core network, the local cache server will connect via the Internet to a related server to obtain the object corresponding to the request in the packet. Finally, the cache object corresponding to the request in the packet is sent back to the site which transmits the object to a user entity.

In addition, a mobile communication network or a local area network can be connected to an aggregation point. The aggregation point is provided with a transmission unit and the cache server can be integrated with this transmission unit. Moreover, a cache server may generate a cache digest based on the cached objects stored therein and this cache digest can be transmitted to other cache servers to inform them of the cached objects it contains.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed. description.

### BRIEF DESCRIPTION OF THE DRAWINGS

The related drawings in connection with the detailed description of the present invention to be made later are described briefly as follows, in which:

FIG. 1(a) is a schematic diagram of a system architecture of a telecommunication network aggregation cache system according to an embodiment of the present invention;

FIGS. 1(b) & 1(c) are schematic diagrams of system architectures of a site of a telecommunication network aggregation cache system according to an embodiment of the present invention;

FIG. 2 is schematic diagram of a system architecture of a telecommunication network aggregation cache system according to an embodiment of the present invention;

FIG. 3 is a flowchart of the steps of a telecommunication network aggregation cache method according to an embodiment of the present invention;

FIG. 4 is a schematic diagram of a user-plane packet format according to an embodiment of the present invention;

FIG. 5 is a flowchart of the steps of a cache replacement method according to an embodiment of the present invention; and

FIG. 6 is a schematic diagram showing an arrangement of cache servers in implementing a coordinated pre-acquiring method according to an embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

The present invention provides a telecommunication network aggregation cache system and method utilizing an aggregation point as a relay point. Through the application of a cache sever provided in the aggregation point, objects that are required can be obtained and transmitted back in a caching way. As a result, high level backhaul bandwidth is saved and the efficacy of communications is increased. In the following, preferred embodiments are described in explaining the technical characteristics of the present invention.

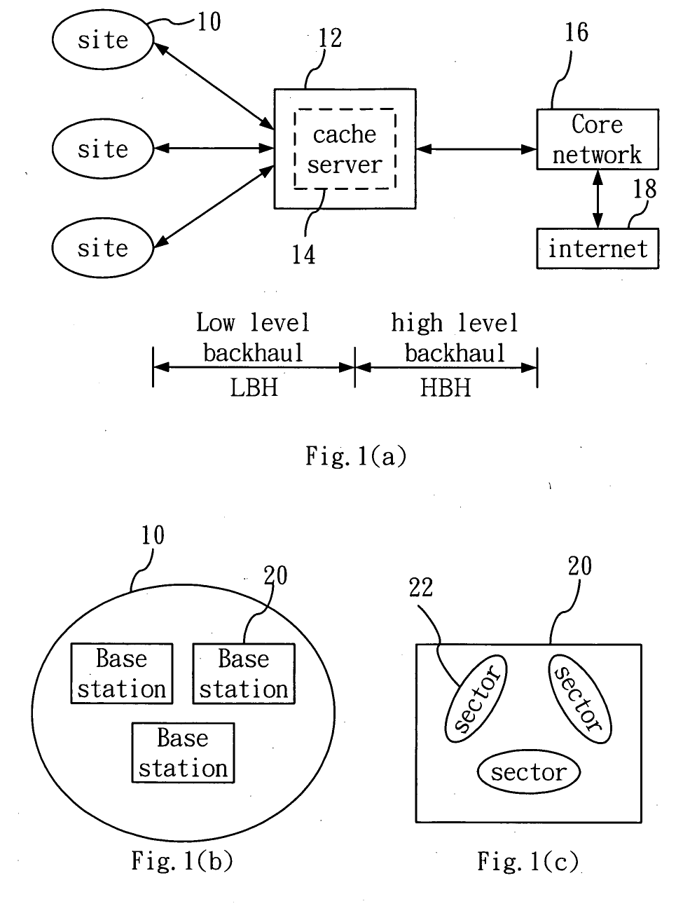

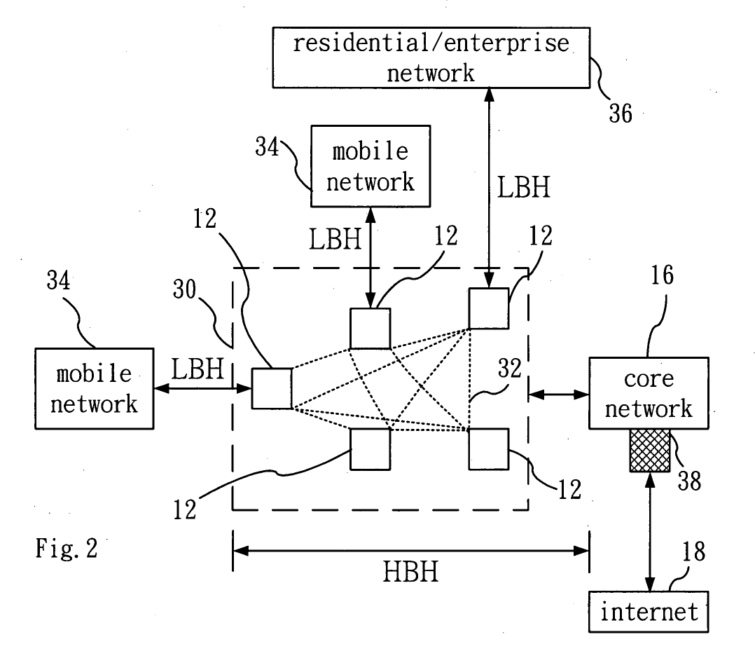

Refer to FIGS. 1(a)-1(c) for diagrams of system architectures of a telecommunication network aggregation cache system according to an embodiment of the present invention. As shown in the figures at least one site 10 is provided. Each site 10 comprises at least one base station 20. In the embodiments illustrated in FIGS. 1(a)-1(b) three sites 10 are provided with each site comprising three base stations 20. However, in other embodiments of the present invention other arrangements are utilized.

For the present telecommunication architecture in Taiwan, the three base stations 20 may be the base stations belonging respectively to Chunghwa Telecom, FarEastone, and Taiwan Mobile and each of the base stations 20 is provided with at least one sector 22 as shown in FIG. 1(c). A base station 20 includes three sectors 22, and each of the sectors 22 is responsible for the transmission and receiving of data in a range of 120°. The site 10 receives at least one packet sent by a user entity through a sector 22 and transmits the packet to an aggregation point 12 through a low level backhaul (LBH) aggregation route. The aggregation point 12 is provided with a cache server 14 that is used to store cache objects such as a hypertext (HTML) file, an image file, an audio-video file, or pieces of a point-to-point (P2P) file. The aggregation point 12 will check the request contained in a user-plane packet and send back to the site 10 the cached objects stored in the cache server 14 corresponding to the request in the packet. The site 10 receives the cached object through a sector 22 of a base station 20 and transmits it to a user entity. Alternatively, the aggregation point 12 will transmits the packet to a core network 16 connected to the Internet 18 through a high level backhaul (HBH) aggregation route. In addition, the aggregation point 12 is provided with a transmission unit as a transmission means between the aggregation point 12 and the site 10. The cache server 14 can be integrated with the transmission unit between the aggregation point 12 and the core network 16.

In the above description, a single aggregation point 12 is arranged between a site 10 and a core network 16. However, a plurality of aggregation points 12 can be utilized to form a mesh network 30, as described in more detail as follows.

Refer to FIG. 2 for a diagram of a system architecture of a telecommunication network aggregation cache system according to an embodiment of the present invention. As shown in FIG. 2, a plurality of aggregation points 12 each containing a cache server 14 are used to form a mesh network 30 with each pair of aggregation points 12 connected through a virtual connection 32. For example, a multi-point to multi-point architecture in a Carrier Ethernet Specification can be utilized to establish point-to-point Ethernet Virtual Connection (EVC), so that aggregation points 12 are connected to one another as neighboring caches. Furthermore, a mobile communication network 34 formed by sites 10 and a residential or enterprise local area network 36 are connected to the aggregation points 12 of the mesh network 30 through a low level backhaul (LBH) aggregation route. The mesh network 30 is connected to the core network 16 through a high level backhaul (HBH) aggregation route. A data network gateway 38 such as a packet data network gateway (PDN-GW) in an LTE specification is provided in the core network 16. The core network 16 is connected to the Internet 18 through the data network gateway 38 and a cache server 14 can be provided in the data network gateway 38. The cache server 14 located in a data network gateway 38 is referred to as a parent cache and cache servers 14 in a mesh network 30 are referred to as child caches.

The packet sent from a user entity is received by a mobile communication network 34 or a residential or enterprise local area network 36 and is transmitted to an aggregation point 12. The aggregation point 12 checks the request in the packet and searches subsequently the local cache server 14, the cache server 14 in the neighboring aggregation point 12, and the cache server 14 in the data network gateway 38 to determine whether the cache object corresponding to the request in the packet is stored in one of them. If a match is found the cached object is obtained and transmitted back to the mobile communication network 34 or the residential or enterprise local area network 36 that originally sent out the packet which then transmits the cache object to the user entity. Alternatively, the aggregation point obtains the cache object corresponding to the request in the packet directly from the Internet 18 connected to the core network 16 and transmits the obtained object to the mobile communication network 34 or the residential or enterprise local area network. 36 that originally sent out the packet which then transmits the object to the user entity.

Moreover, each of the cache servers 14 will generate a cache digest based on the cached objects stored therein and broadcasts the cache digests periodically to inform one another of the cache objects it contains. The broadcasting time of the cache digests can be set at an off-peak time such as midnight to avoid affecting the user entity's experience and to enable the cache servers 14 to have sufficient time to pre-download cached objects from one another.

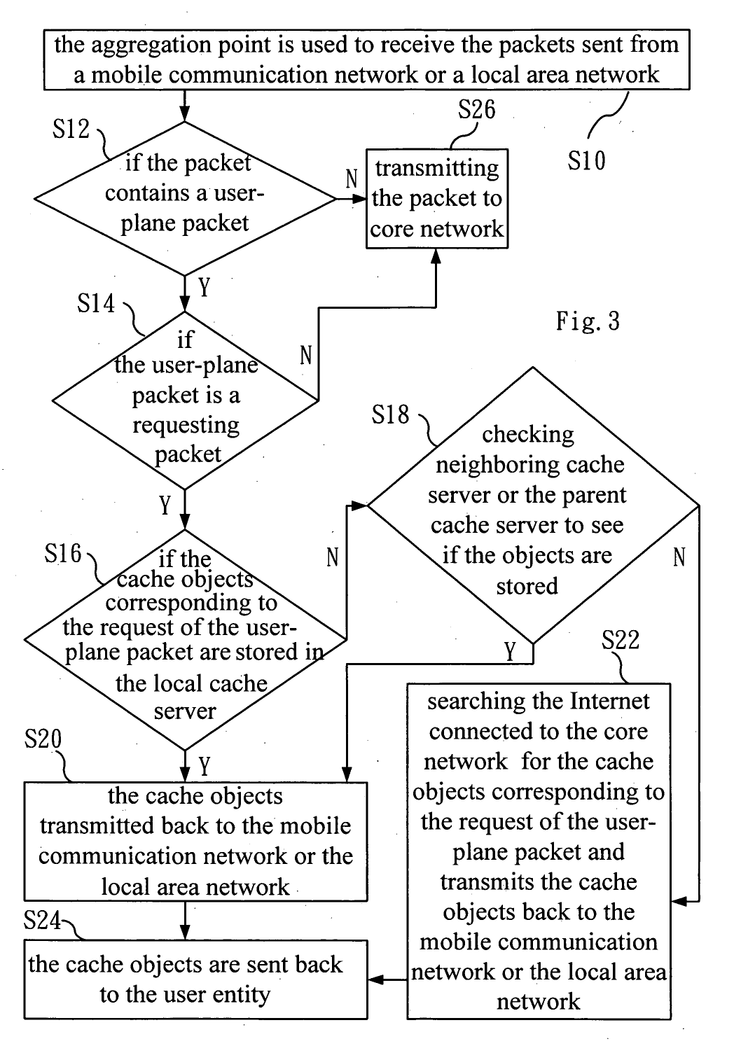

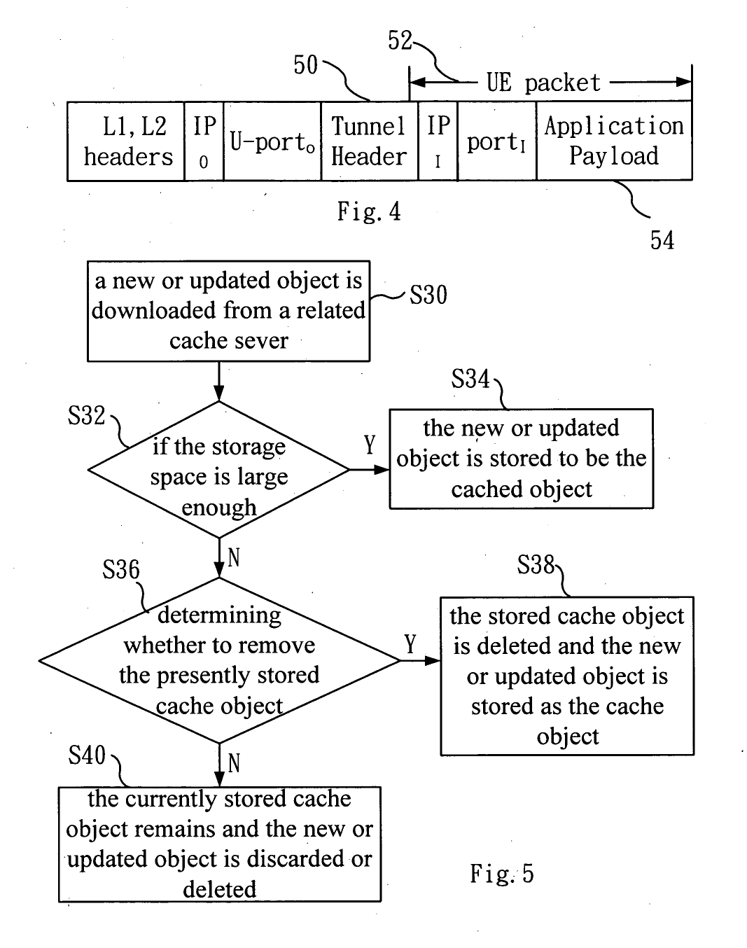

Refer to FIG. 3 for a flowchart of the steps of a telecommunication network aggregation cache method according to the present invention; to FIG. 1(a) & FIG. 2 for diagrams of system architectures of telecommunication network aggregation cache system according to embodiments of the present invention; and to FIG. 4 for a diagram of a user-plane packet format according to the present invention.

Firstly, as shown in step S10, the aggregation point 12 is used to receive the packets sent from a mobile communication network 34 or a local area network 36.

Next, as shown in step S12, the aggregation point 12 checks to see if the packet contains a user-plane packet. The aggregation point 12 checks if the packet is wrapped with a layer of tunnel header 50 in determining whether the packet is a user-plane packet, so as to exclude control-plane packets which are otherwise forwarded to the core network 16 as shown in step S26. The category of tunnel header 50 may include a GPRS Tunneling Protocol-User Plane (GTP-U), a Generic Routing Encapsulation (GRE), etc.

Then, as shown in step S14, the aggregation point 12 checks to see if the user-plane packet is a requesting packet. The aggregation point 12 checks the application payload 54 contained in a user entity packet 52 that is a user-plane packet in determining whether the packet is a requesting packet, and as shown in step S26, forwards the user-plane packet that is not a requesting packet to the core network 16.

Subsequently, as shown in step S16, the aggregation point 12 determines if the cache objects corresponding to the request of the user-plane packet are stored in the local cache server 14. If the objects are found they are transmitted back to the mobile communication network 34 or the residential or enterprise local area network 36 in step S20. Then, as shown in step S24, the cache objects are sent back to the user entity through the mobile communication network 34 or the residential or enterprise local area network 36.

If the cache objects requested in the user-plane packet are not found on the local cache server 14, then, as shown in step S18, the aggregation point 12 checks a neighboring cache server 14 or the parent cache server for the objects. If found, then as shown in step S20, the cache objects are transmitted back to the mobile communication network 34 or the local area network 36. Afterwards, as shown in step S24, the cache objects are sent to the user entity through the mobile communication network 34 or the local area network 36.

If the cache objects requested in the user-plane packet are not found on a local cache server, a neighboring cache server, or a parent cache server, then, as shown in step S22, the aggregation point 12 searches the Internet 18 connected to the core network 16 for the cache objects corresponding to the request in the user-plane packet and transmits the cache objects back to the mobile communication network 34 or the local area network 36. Then, as shown in step S24, the cache objects are sent to the user entity through the mobile communication network 34 or the local area network 36.

In addition, the cache server 14 may perform cache replacement in storing a brand new or updated object to be a cached object. In the following, the cache replacement method will be described in detail.

Refer to FIG. 5 for a flowchart of the steps of a cache replacement method according to the present invention. As shown in step S30, a new or updated object is downloaded from a related cache sever. Next, as shown in step S32, the cache server 14 determines if the storage space is large enough. If the storage space is large enough, then, as shown in step S34, the new or updated object is stored to be the cached object. If the storage space is not large enough, then, as shown in step S36, the cache server 14 determines whether to remove the presently stored cache object. For this purpose the cache server 14 utilizes a selection algorithm in calculating the weight, value, or importance of the cache object based on the storage capacity and user access frequency. When the value of the new or updated object is higher than that of the currently stored cache object, then, as shown in step S38, the stored cache object is deleted and the new or updated object is stored as the cache object. Otherwise, as shown in step S40, the currently stored cache object remains and the new or updated object is discarded or deleted.

In addition to the cache replacement method described above, the cache server 14 may utilize a separate pre-acquiring method in updating the cached object's version. In this method, the cache server 14 checks the cached objects in an off-peak period and based on the cached object's cache frequency and storage time determines if it will proactively go to the related website of the cache object to fetch the latest version and update the cache object. For example, if a cached object in a cache server 14 is requested frequently by a user entity and its storage time is relatively long, the cache server 14 may contact the related website in a pre-acquiring way to see if there is a newer version. Since a website will update the cache objects periodically the cache server 14 proactively checks for newer versions of the cached objects.

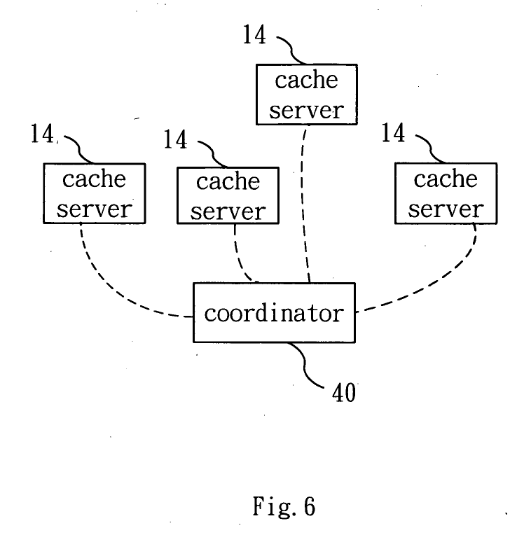

In some cases the individual cache server pre-acquiring method may not be adequate. Therefore the present invention further provides a coordinated pre-acquiring method. Refer to FIG. 6 for a diagram showing an arrangement of cache servers in implementing coordinated pre-acquiring according to the present invention. As shown in FIG. 6 a coordinator 40 is connected to a plurality of cache servers 14 and popular objects are analyzed utilizing the coordinator 40. Popular objects can be found from listings on audio-video sharing websites, for example, daily/weekly/monthly popular ratings of websites such as YouTube, I'm Vlog, and Anonymous. The coordinator 40 can instruct the respective cache server 14 to perform pre-acquiring of popular objects and store them as cache objects.

Through the implementation of the above-mentioned cache replacement, individual cache server pre-acquiring, or coordinated cache servers pre-acquiring methods, the cache hit rate is raised.

The present invention further provides a piece-wise caching method utilized by a cache server 14 for storing cache objects. In this method a cache object is divided into a plurality of pieces which are stored separately on various cache servers 14, such that each cache server 14 stores a small portion of the cache object. For example, a cache object of size S is divided into pieces and stored in a piece-wise caching way on N cache servers 14 so that S/N storage space is occupied on each cache server 14. The larger the value of N results in a smaller occupied storage space on each cache server 14 thereby increasing the utilization rate of the storage space of a cache server 14 and effectively reducing hardware costs.

In the present invention an aggregation point 12 or a mesh network 30 formed by a plurality of aggregation points 12 is utilized as a relay point for communication. A cache method is utilized where the cache server 14 provided in the aggregation point 12 is used to store cache objects. After the aggregation point 12 checks the request in a user-plane packet, the cache object corresponding to the request is sent back to the requesting entity, therby effectively saving the bandwidth used for high level backhaul (HBH).

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A telecommunication network aggregation cache system, comprising:
at least one site for receiving and transmitting at least one packet; and
at least one aggregation point connected to the site, each aggregation point comprising a cache server for storing cache objects, the aggregation point for receiving the packet, checking a request of the packet, and then sending a cache object corresponding to the request of the packet to the site, or sending the packet to a core network.

2. The telecommunication network aggregation cache system as claimed in claim 1, further comprising:
at least one base station located in the site, the base station comprising at least one sector for receiving and transmitting the packet and the cache object.

3. The telecommunication network aggregation cache system as claimed in claim 1, wherein a plurality of aggregation points are connected to one another through a virtual connection to form a mesh network.

4. The telecommunication network aggregation cache system as claimed in claim 1, wherein the aggregation point is connected to a local area network.

5. The telecommunication network aggregation cache system as claimed in claim 1, further comprising:
a data network gateway for connecting the core network to the Internet, the data network gateway comprising a cache server.

6. The telecommunication network aggregation cache system as claimed in claim 5, wherein the cache server in the data network gateway is a parent cache.

7. The telecommunication network aggregation cache system as claimed in claim 3, wherein each cache server in the mesh network is a child cache.

8. The telecommunication network aggregation cache system as claimed in claim 1, wherein connection between the site and the aggregation point is a low level backhaul.

9. The telecommunication network aggregation cache system as claimed in claim 4, wherein connection between the local area network and the aggregation point is a low level backhaul.

10. The telecommunication network aggregation cache system as claimed in claim 1, wherein connection between the core network and the aggregation point is a high level backhaul.

11. The telecommunication network aggregation cache system as claimed in claim 1, further comprising:
a transmission unit disposed in the aggregation point for transmission means between the aggregation point and the site and for transmission means between the aggregation point and the core network.

12. The telecommunication network aggregation cache system as claimed in claim 11, wherein the cache server is integrated with the transmission unit.

13. The telecommunication network aggregation cache system as claimed in claim 1, wherein the cache server generates a cache digest based on cached objects and broadcasts the cache digest to other cache severs.

14. The telecommunication network aggregation cache system as claimed in claim 1, wherein the cache object comprises a hypertext (HTML) file, an image file, an audio-video file, or pieces of a point-to-point (P2P) file.

15. A telecommunication network aggregation cache method, comprising the following steps:
receiving by an aggregation point a packet sent by a mobile communication network, and checking a request of the packet;
searching a cache server by the aggregation point for a cache object based on the request and sending the cache object corresponding to the request back to the mobile communication network; and
sending the cache object to a user entity by the mobile communication network.

16. The telecommunication network aggregation cache method as claimed in claim 15, wherein the aggregation point checks whether the packet contains a user-plane packet and sends packets that are not user-plane packets to a core network.

17. The telecommunication network aggregation cache method as claimed in claim 16, wherein the aggregation point checks whether the user-plane packet is a requesting packet and sends user-plane packets that are not requesting packets to the core network.

18. The telecommunication network aggregation cache method as claimed in claim 15, wherein if the cache object based on the request is not found on a local cache server the aggregation point searches for the cache object on a neighboring cache server.

19. The telecommunication network aggregation cache method as claimed in claim 18, wherein if the cache object based on the request is found on the neighboring cache server the aggregation point sends the cache object back to the mobile communication network; and
wherein if the cache object based on the request is not found on the neighboring cache server the aggregation point searches a core network cache server for the cache object.

20. The telecommunication network aggregation cache method as claimed in claim 19, wherein if the cache object based on the request is found on the core network cache server the aggregation point sends the cache object back to the mobile communication network; and
wherein if the cache object based on the request is not found on the core network cache server the aggregation point searches the Internet via the core network, retrieves the cache object, and sends the cache object back to the mobile communication network.

21. The telecommunication network aggregation cache method as claimed in claim 15, further comprising:
storing a new cache object or an updated cache object when storage space of the cache server is sufficient.

22. The telecommunication network aggregation cache method as claimed in claim 21, wherein if storage space of the cache server is insufficient the aggregation point determines whether to delete a currently stored cache object or discard the new cache object.

23. The telecommunication network aggregation cache method as claimed in claim 15, further comprising:
pre-acquiring and updating the cache object by the cache server.

24. The telecommunication network aggregation cache method as claimed in claim 15, further comprising:
receiving a pre-acquiring notice from a coordinator by the cache server and updating cache objects based on the pre-acquiring notice.

25. The telecommunication network aggregation cache method as claimed in claim 15, wherein the cache server of each aggregation point performs caching of the cache object in a piece-wise caching way so that pieces of the cache object are stored on different cache servers.

26. The telecommunication network aggregation cache method as claimed in claim 15, wherein the packet is sent to the aggregation point via a local area network.

27. The telecommunication network aggregation cache method as claimed in claim 15, wherein the user entity is a portable mobile communication device.
